(19) United States
(12) Patent Application Publication
(10) Pub. No.: US 2016/0318070 A1
(43) Pub. Date: Nov. 3, 2016

(54) Disc for Disc Screen and Method of Manufacture

(71) Applicant: Nicholas Davis, San Diego, CA (US)

(72) Inventor: Nicholas Davis, San Diego, CA (US)

(73) Assignee: CP MANUFACTURING, INC., San Diego, CA (US)

(21) Appl. No.: 14/797,090

(22) Filed: Jul. 11, 2015

Related U.S. Application Data
(60) Provisional application No. 62/153,901, filed on Apr. 28, 2015.

(51) Int. Cl. B07B 1/15; B29C 45/26

(52) U.S. Cl. CPC B07B 1/15; B29C 45/2675; B29L 2015/00

(57) ABSTRACT

A new and novel disc for use in a disc screen apparatus is disclosed. In one embodiment, the disc comprises a hub having a central bore, and a plurality of impacting arm elements extending radially therefrom, each of the impacting arm elements comprising an impacting arm and an impacting arm end portion, the impacting arm elements configured for engaging materials to be classified and propelling the materials in a conveying direction when the hub is rotated, at least some of the impacting arm elements comprising texturing imposed on a surface of one of the end portions for engaging the materials as the hub is rotated.

### RELATED APPLICATIONS

This application claim priority as the non-provisional of U.S. Patent Application 62/153,901 filed on Apr. 28, 2015, the contents of which are fully incorporated herein by reference.

This application is also related to U.S. Patent Application 62/037,038 filed on Aug. 13, 2014, converted to non-provisional application Ser. No. 14/797,088 filed on Jul. 11, 2015; U.S. Patent Application 62/160,219 filed on May 12, 2015; and U.S. Patent Application ______ entitled “Rotating Suction Chamber Apparatus” filed on Jul. 11, 2015; all of which are assigned to the same assignee and have a common inventor with the present application. Each of these applications is incorporated herein by reference.

### TECHNICAL FIELD

The present disclosure relates to sorting machines used to separate mixed, recyclable materials into different fractions and, more particularly, to a disc construction used in such sorting machines.

### BACKGROUND

Inclined rotary disc screens are used in the recycling industry to separate paper from plastic and metal containers. These disc screens typically comprise a number of shafts arranged in a parallel relationship with each in a frame, each shaft having a plurality of discs installed on to them. Each of the discs typically comprises a hub with a central bore formed therethrough, and a number of “impacting arms” arranged radially from the hub. The impacting arms generally comprise end portions having a smooth, curved surface for contact with the recyclable materials. The smooth surface is used both to reduce tooling and press costs.

In the current state of the art, the discs are typically manufactured as a unitary structure, typically made of a rubber material such that there is a high coefficient of friction between the disc and recyclable material, which generally moves in an upward direction across the screen. The friction causes the discs to wear and eventually to need replacement. Disc replacement costs are one of the driving operational cost factors in the recycling industry.

In general, the softer the rubber compound used to manufacture discs, the higher the coefficient of friction between the disc and recyclable material so that the disc performs better both in throughput and separation efficiency. However, a softer disc will wear faster, resulting in higher disc replacement costs. Thus, there is a tradeoff between performance and wear life in choosing materials from which to construct discs.

Additionally, where discs are constructed using pressing or molding techniques, the formulation of the disc material used in the press process affects both disc quality and cost. Cost and quality affect overall disc value in the same manner described above, with higher quality material adding value but having higher replacement costs.

It would be desirable to increase the quality of such discs, while maintaining or even reducing manufacturing costs.

### SUMMARY

The embodiments described herein relate to a new and novel disc for use in a disc screen sorting device typically used in the recycling industry, and a method of manufacture of the disc.

In one embodiment, the disc comprises a hub having a central bore, and a plurality of impacting arm elements extending radially therefrom, each of the impacting arm elements comprising an impacting arm and an impacting arm end portion, the impacting arm elements configured for engaging materials to be classified and propelling the materials in a conveying direction when the hub is rotated, at least some of the impacting arm elements comprising texturing imposed on a surface of one of the end portions for engaging the materials as the hub is rotated.

In another embodiment, a disc screen apparatus for separating materials is described, comprising, a frame, one or more shafts mounted on the frame in a substantially parallel relationship with each other, and one or more discs mounted on each of the one or more shafts, each disc comprising a hub having a central bore, and a plurality of impacting arm elements extending radially therefrom, each impacting arm element comprising an impacting arm and an impacting arm end portion, the impacting arm elements configured for engaging materials to be classified and propelling the materials in a conveying direction when the hub is rotated, at least some of the impacting arms comprising texturing imposed on a surface of one of the end portions for engaging the materials as the hub is rotated.

In yet another embodiment, a method of manufacture of a disc is described, comprising forming a first mold half comprising a void in the shape of a hub, voids representing impacting arms extending radially from the hub, and voids representing impacting arm end portions, forming a second mold half comprising voids corresponding to the voids of the first mold half, forming one or more impacting arm end molds, placing a respective one of the one or more impacting arm end molds within the first mold half in proximity to a respective impacting arm end portion void, placing the second mold half on top of the first mold half to form a disc mold, filling the disc mold with a first material in the disc mold to form the disc, removing the disc from the disc mold, and removing the impacting arm end molds from the disc.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a side view illustration of one embodiment of an inclined sorting apparatus used in the recycling industry;

FIGS. 2A, 2B and 2C illustrate a top view of three embodiments of a disc screen used in the inclined sorting apparatus shown in FIG. 1;

FIG. 3 illustrates one embodiment of one of the shafts of the inclined sorting apparatus shown in FIG. 1, having a first textured disc mounted thereon, and a second, non-textured disc in position for mounting;

FIG. 4 illustrates one embodiment of a disc used in the sorting apparatus of FIG. 1;

FIG. 5 is a flow diagram illustrating one embodiment for manufacturing textured or non-textured discs for use in a disc screen such as either disc screen shown in FIGS. 1 and 2;

FIG. 6 is top view illustration of one embodiment of a primary mold for manufacturing textured and non-textured discs and a number of impacting end portion molds;

FIG. 7 is a close-up view of one of one embodiment of an impacting arm end mold used to form impacting arm end portions of the textured or non-textured discs;

FIG. 8 is a close-up view of one embodiment of texturing that may be added to an end portion of an impacting arm of the disc shown in FIG. 4; and

FIG. 9 is a close-up view of close-up example illustration one of the impacting arm end molds shown in FIG. 7 positioned within a corresponding end portion void of shown in FIG. 6.

### DETAILED DESCRIPTION

The present disclosure describes several embodiments of a new and novel disc for use in a material sorting apparatus and a method for manufacturing the disc.

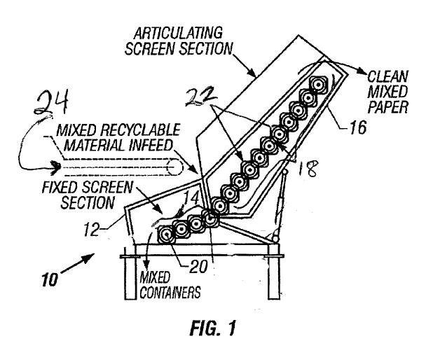

FIG. 1 is a side view illustration of one embodiment of a sorting apparatus 10 used in the recycling industry to sort recyclable materials. In this embodiment, the sorting apparatus 10 operates as a single, continuous waste-classifying screen having end-to-end upstream and downstream sections. Sorting apparatus 10 separates a stream of mixed recyclable materials of various sizes and shapes entering on conveyer 24, the stream including newspaper, clean mixed paper, magazines, plastic bottles, glass bottles and jars, cans, and the like. Sorting apparatus 10 includes fixed first frame 12 that supports a first inclined disc screen section 14, and an articulating second frame 16 that supports a second inclined disc screen section 18. Each disc screen section is comprised of a plurality of rotatable shafts 20 whose axes are spaced apart and parallel, and extend laterally between opposite sides of frames 12 and 16. The shafts are located at progressively greater heights spaced along the longitudinal conveying direction (from left to right in FIG. 1). Each of the shafts 20 comprises two or more textured and/or non-textured discs 22 for separating a stream of recyclable materials into fractional elements.

As the shafts 20 rotate, they cause the discs 22 to also rotate, which acts to separate the stream of recyclable materials into mixed containers that fall to the left of inclined disc screen section 14 and clean, mixed paper that is expelled upwards, to the right of second inclined disc screen section 18, in this embodiment. Further details of this particular type of sorting apparatus can be found in U.S. Pat. No. 7,004,332 entitled “Articulating Disc Screen Apparatus for Recyclable Materials”, assigned to the assignee of the present disclosure and incorporated by reference herein in its entirety.

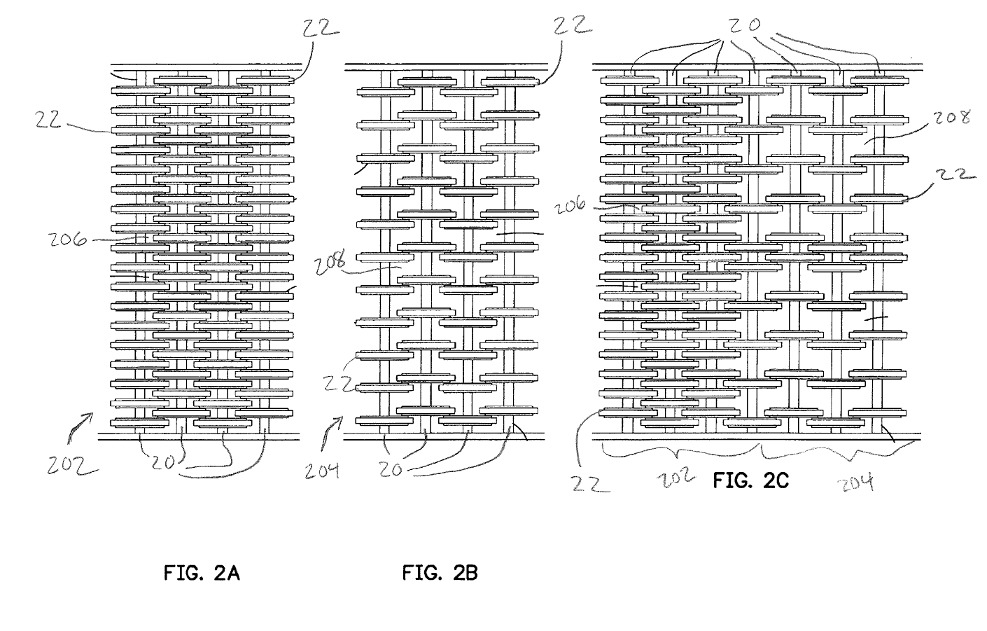

FIGS. 2A, 2B and 2C show examples of three disc screens having discs 22 mounted on a number of rotatable shafts 20, with varied spacing, creating a variety of screen patterns. FIGS. 2A and 2B show examples of two screen patterns 202 and 204 of the discs 22 mounted on the rotatable shafts 20. FIG. 2A shows the discs 22 mounted on the shafts in a fine screen pattern, with small spaces between the edges of the discs 22 and adjacent shafts. One such space is indicated by 206. This fine screen pattern 202 is used in the apparatus where small materials are screened. In FIG. 2B, the discs 22 are mounted in a gross screen pattern with large openings such as 208 such that larger, heavier materials are able to fall through the openings 208 between the discs 22. In some cases, it may be desirable to have a combination of spacings between the discs (i.e., have both small openings 206 and large openings 208). In this way, as the material stream travels along a plurality of rotating shafts 20, the mixed material is separated and screened in successive stages on one disc screen. One example combination pattern formed by varying the screen patterns is shown in FIG. 2C. In this regard, as the material stream pours onto the disc screen apparatus over the fine screen pattern 202, the material stream is agitated and moved by rotation of the discs with the shafts toward and over the gross screen pattern 204. Over the fine screen pattern 202, relatively fine grit, glass shards, and other small materials are screened out. Over the gross screen pattern 204, larger objects such as cans and bottles pass through the larger.

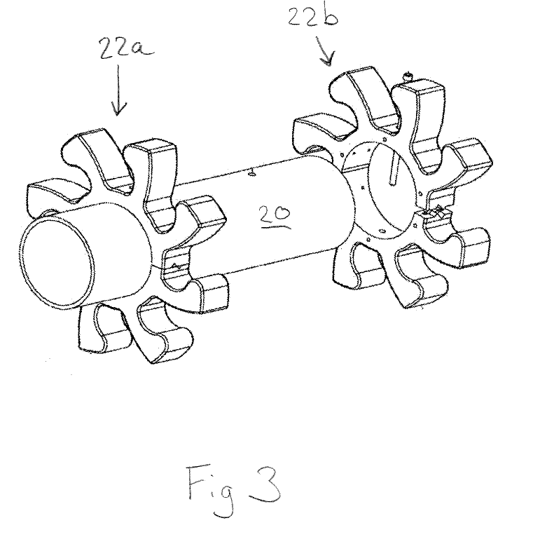

FIG. 3 illustrates one embodiment of one of the shafts 20 described in FIGS. 1 and 2, having a first textured disc 22a mounted thereon, and a second, non-textured disc 22b in position for mounting on the shaft 20. Only a portion of the shaft 20 is illustrated in FIG. 3. Although FIG. 3 illustrates the use of both textured and non-textured discs 22 on shaft 20, in practice, typically only one type of disc would be used on each shaft 20, i.e., either textured or non-textured. In some applications, some shafts 20 of disc screen 14 or 18 may comprise textured discs 22a, while other shafts 20 may comprise non-textured discs 22b. For example, in one embodiment, first inclined disc screen section 14 could comprise non-textured discs 22b, while second inclined disc screen section 18 could comprise textured discs 22a. The shaft 20 is typically long enough to support a dozen or more discs 22 spaced apart from one another, or abutting one another. The ends of the shaft 20 are supported by bearing assemblies (not illustrated) of disc screen sections 14 or 18, such as those disclosed in U.S. Pat. No. 6,250,478 entitled, “Stepped Disc Screens of Unequal Inclination Angles for Conveying and Grading Recycling Materials” and U.S. Pat. No. 6,648,145 entitled, “V-Shaped Disc Screen and Method of Classifying Mixed Recyclable Materials into Four Streams”, both of which are assigned to the assignee of the present disclosure and incorporated by reference herein in their entirety. Either of the discs 22a or 22b may be installed onto shaft 20 by a variety of methods, also describes in the aforementioned patents assigned to the assignee of the present disclosure.

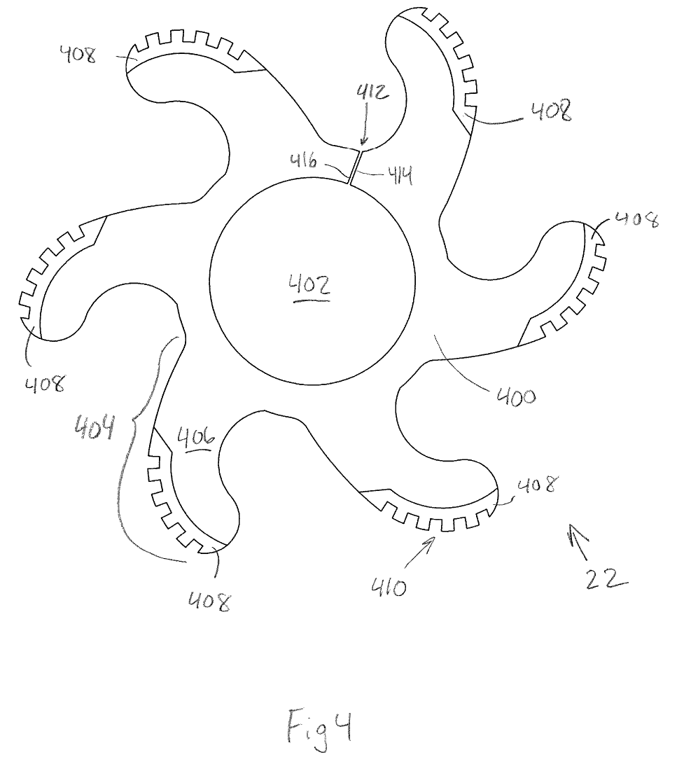

FIG. 4 illustrates one embodiment of disc 22, shown as having textured end portions 408. In another embodiment, the end portions 408 are not textured. The disc 22 is specially configured for use in classifying mixed recyclable materials. Disc 22 comprises a hub 400 typically formed of an elastomeric material, i.e. a rubber-like synthetic polymer such as silicone rubber or polyurethane having a central bore 402. The hub 400 is generally ring-shaped but may be of other shapes in alternative embodiments. In this embodiment, disc 22 comprises a unitary hub 400 with a split 412 defining a pair of opposing ends 414 and 416, so that the disc may be installed onto shaft 20 without having to remove shaft 20 from frame 12. The ends 414 and 416 are joined together by a fastening device (not shown) after disc 22 is installed onto shaft 20. Such an embodiment is described in U.S. Pat. No. 8,522,983 entitled, “Disc For Disc Screen” which is assigned to the assignee of the present disclosure and incorporated by reference herein in its entirety. In other embodiments, hub 400 may comprise two or more sections joined together by fastening devices such as screws, or nuts and bolts, as described in the '478 patent mentioned above.

Disc 22 further comprises a plurality of outer impacting arm elements, one of which is labeled as reference numeral 404 in FIG. 4, in the form of radially extending arms that are supported on the hub 400 and are configured for engaging recyclable materials to be classified and for propelling the materials in a conveying direction when disc 22 is rotated. The impacting arm elements 404 each comprise an impacting arm 406 and an impacting arm end portion 408 (referred to herein as simply as “end portion 408”). In one embodiment, at least one end portion 408 comprises a material having at least one different, physical or chemical property than impacting arm 406 or hub 400. For example, in one embodiment, end portion 408 may comprise texturing formed on a leading edge 410 of end portion 408, having a slightly curved shape that engages materials to be classified. Thus, in this embodiment, the end portion 408 comprises texturing, while impacting arm 406 and hub 400 does not.

The texturing of the end portion 408 increases the efficiency of the disc screen by reducing the “air pillow” effect. During operation the discs 22 are rotated at very high speed and the discs 22 act as air impellers that create an “air pillow” upon which the material to be classified may float. The material, therefore, is not contacted by the discs 22 and does not travel through the disc screen. Texturing overcomes this inefficiency in several ways. For example, texturing creates a larger surface area which contacts the material to be classified and thus has a higher possibility of forcing the material through the disc screen. Texturing also allows the tips of the textured pattern to flex when they come into contact with the materials to be classified, again increasing the contact surface area and the efficiency in pushing the material through the disc screen. Finally, texturing creates channels through which air can evacuate, while simultaneously allowing the tips of the textured pattern to come into contact with the material to be classified. While FIGS. 4, 6, and 8 illustrate the texturing as a chevron, it would be apparent that several three dimensional surfaces would provide the benefits of increased surface area contact and the channeling/evacuation of air.

Testing with the textured end portion 408 confirms that the sorting is much more efficient than a smooth end portion. And because it was more efficient (i.e., greater and more frequent contact with materials to be classified) the textured end portion 408 may wear more quickly. To address this, the end portion 408 may comprise a material having physical or chemical properties different than that of the material used to form impacting arm 406 and/or hub 400. The different physical or chemical properties give end portion 408 one or more desirable characteristics, such as greater durability, increased coefficient of friction, reduced material costs, or some combination of these and/or others. For example, end portion 408 in one embodiment could be made of a material that is more durable than the material used to form impacting arms 406. In another embodiment, the material used to form the end portions 408 is the same material of impacting arm elements 404 and/or hub 400, but having additives that result in a physical property being different from a physical property of the material alone. For example, one or more additives could be added to polyurethane to make the material that forms end portions 408 harder, softer, more durable, less costly, greater durometer than the same material that forms impacting arm elements 404. Such additives are well-known in the art. In another embodiment, the material used to form the end portions 408 has a higher, or lower, coefficient of friction than the remaining portion of the outer impacting arm elements 404. In yet another embodiment, the material used to form the end portions 408 is harder, or softer, than the material used to construct impacting arm 406 and/or hub 400. In yet still another embodiment, the material used to form the end portions 408 is of a higher, or lower, quality than the material used to construct impacting arm 406 and/or hub 400. In one embodiment, hub 400 and impacting arms 406 comprise a low durability material, while end portions 408 are textured, using a high durability material. In this way, only a small quantity of high-quality material is used, thus reducing material costs, while affording end portions 408 with desirable chemical and mechanical properties for engaging particular types of recyclable materials, such as paper. The high-durability material provides better wear life while decreasing performance (i.e., the ability of disc 22 to grip certain recyclable materials), while the texturing increases performance while decreasing wear life. The net effect is a disc having much better performance and wear properties with only a marginal increased cost.

Constructing the end portions 408 with a material having physical or chemical properties different than that of the material used to form impacting arm 406 and/or hub 400 can also be implemented without texturing. For example, the end portions 408 described in U.S. Pat. No. 8,522,983 may be so constructed to improve performance and wear properties with only a marginal increased cost.

The end portions 408 may be formed using a number of methods. In one embodiment, the end portions 408 are formed separately from the impacting arms 406 and/or hub 400, and then attached to impacting arms 406 using conventional fastening methods such as one or more of adhesives and/or fastening devices, such as nuts, bolts, rivets, and/or screws. In this embodiment, especially when texturing is present, the end portions 408 are able to be removed from their molds with ease, thereby preventing damage to an entire disc if such a textured disc were to be made in a single mold. In another embodiment, the end portions 408 are made from a different material than impacting arms 406 and attached during the manufacturing process using one or more adhesives, heat, pressure, or other techniques known in the art. Further description of the manufacturing process is discussed below.

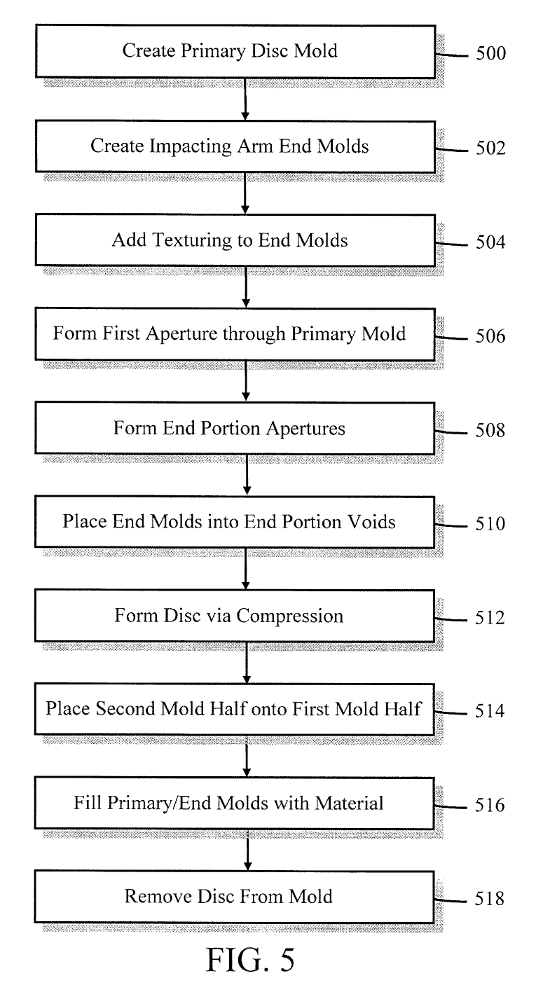

FIG. 5 is a flow diagram illustrating one embodiment for manufacturing textured or non-textured discs for use in a disc screen such as either disc screen shown in FIGS. 1 and 2. It should be understood that in some embodiments, not all of the steps shown in FIG. 5 are performed, and that the order in which the steps are carried out may be different in other embodiments. It should be further understood that some minor method steps may have been omitted for purposes of simplifying the method description.

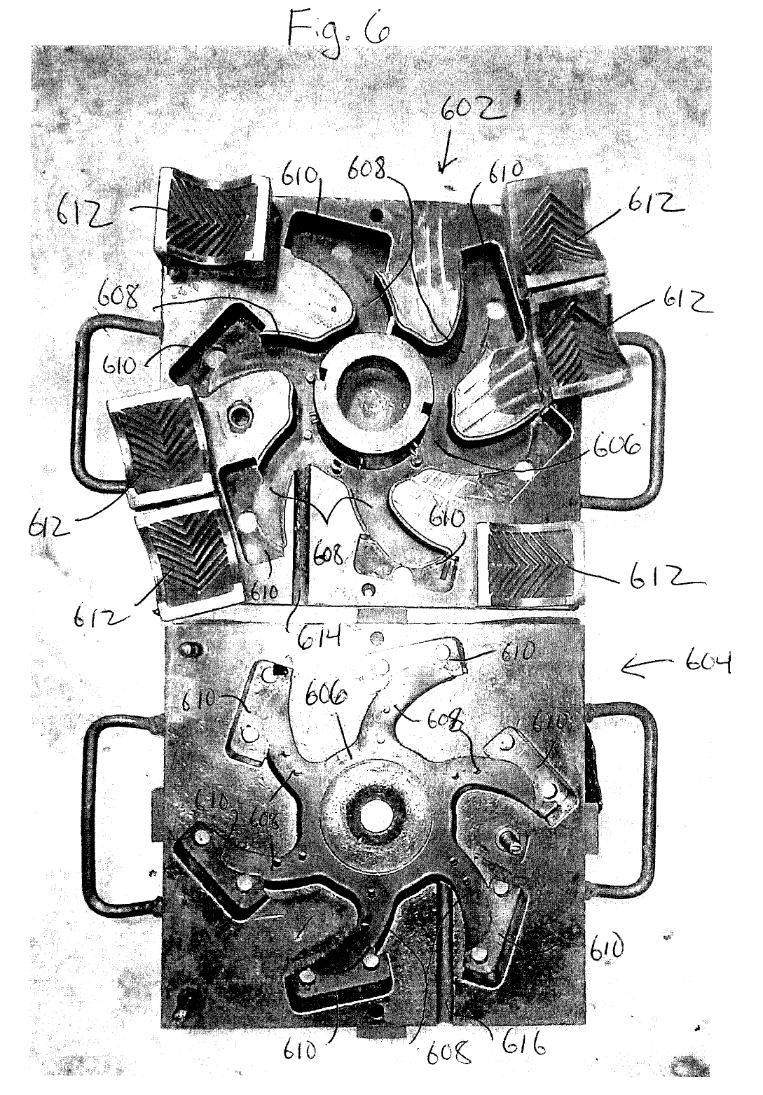

At block 500, a primary disc mold is created, such as primary disc mold 600 shown in FIG. 6, primary disc mold 600 comprising a first mold half 602 and a complementary second mold half 604. Also shown in FIG. 6 are a number of end portion molds 612 placed on a surface of primary disc mold half 602 for viewing purposes. Each of the mold halves comprises a void 606 in the shape of a negative of hub 400 and voids 608, each in a negative shape of an impacting arm 406 extending radially from the hub. Each mold half additionally comprises voids 610 representing a negative of one impacting arm end portion 408 associated with each impacting arm 406. Such a mold 690 is typically formed from an inelastic material, such as aluminum, plastic, ceramic material, or any other material typically used in injection or compression-molding manufacturing methods. Formation of the molds typically comprises hogging out a metallic block of material, casting, or using “3-D” printing techniques.

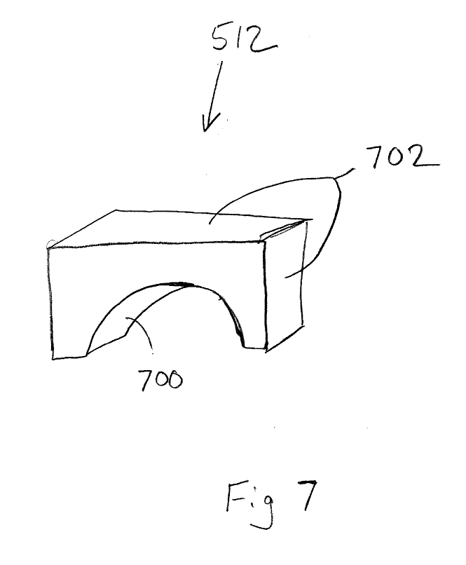

At block 502, a plurality of impacting arm end molds 612 are formed. A close-up view of one embodiment of one of the impacting arm end molds 612 is shown in FIG. 7. Each impacting arm end mold 612 is used to form an end portion 408 for use in one of the impacting arm elements 404. Specifically, each impacting arm end mold 612 comprises an inner, curved surface 700 corresponding to leading edge 410 of end portion 408. An outer surface 702 generally conforms to the shape of the impacting end portion voids 610 formed on both halves of the mold 600. The impacting arm end molds 612 are typically formed from an inelastic material, such as aluminum, plastic, ceramic material, or any other material typically used in injection or compression-molding manufacturing methods. Formation of the molds typically comprises hogging out a metallic block of material, casting, or using “3-D” printing techniques.

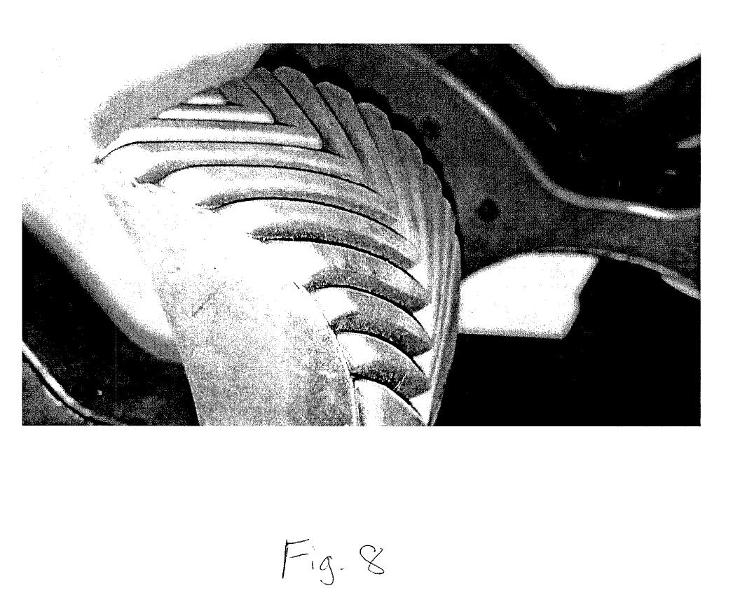

At block 504, texturing may be added to one or more of the end molds 612 by removing or adding material from/to curved surface 602 to form raised and lowered surfaces or “grooves”, which forms the textured surface of each end portion 408 as shown in FIG. 4 and in FIG. 8 in close-up. The texturing may result in a groove depth and width that allows a certain amount of flexing to occur as the curved surface 702 contacts recyclable materials during use. For example, the depth of the groves formed by the texturing process may measure 1/4 inch, while the width of the raised surfaces may measure 1/4 inch, forming a square cross section having a relatively firm flex, as opposed to a groove depth of 1/2 inch and a raised surface width 3/16 inch, resulting in a more relaxed flex.

The texturing may produce end portions 408 that act to both increase the total surface area of the end portions, thus increasing the total force applied against recyclable materials via a coefficient of friction, as well as to provide a “mechanical friction” where the flexing of material in the texture pattern provides additional grip between the disc and the recyclable materials. The process of adding texture to surface 702 is well known in the art and may comprise cutting or hogging. In another embodiment, texturing is added at block 502 during manufacture of the end portion molds 612 in a casting or 3-D printing process.

At block 506, a first aperture half 614 may be formed on the first mold half 602 and a second aperture half 616 formed on the second mold half 604 corresponding to the first aperture half. The aperture halves form a resulting aperture 620 in mold 600 that allows liquid, gel, resin, or semi-cured materials to flow into the voids in mold 600 after the two mold halves have been placed together.

At block 508, end portion apertures 618 may be formed through the first mold half 602 and/or second mold half 604 intersecting the end portion voids 610. End portion apertures 618 are used to allow liquid, gel, resin, or semi-cured materials to flow into the voids 610 after the mold 612 have been placed inside respective voids 610. End portion apertures 618 may be used to fill the end portion voids 610 with a material having different physical or chemical properties than the material provided to voids 606, corresponding to hub 400, and/or voids 608, corresponding to impacting arms 406. For example, the material flowing through end portion apertures 618 forming end portions 408 might comprise a first compound having a first hardness, while material flowing through aperture 620 forming hub 400 and impacting arms 406 might comprise a second compound having a second hardness, elasticity, durometer, coefficient of friction, etc. In other embodiments, the material selected for formation of the end portions 408 might comprise a higher quality compound that wears more quickly or more slowly than the material selected for formation of hub 400 and impacting arms 406, or a compound having a desired coefficient of friction regardless of the material chosen for formation of hub 400 and impacting arms 406.

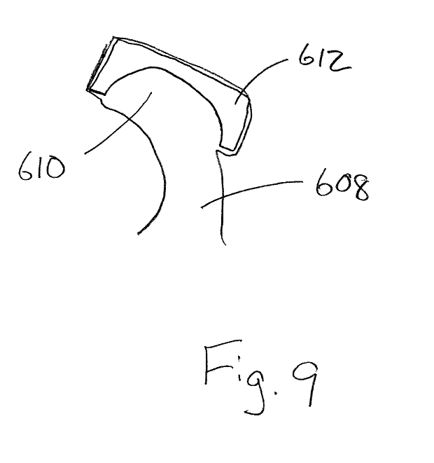

At block 510, each impacting arm end mold 612 is placed within a respective one of the end portion voids 610. The exterior of each impacting arm end mold 612 is formed to fit within the voids 610. A close-up example illustration one impacting arm end mold 612 positioned within a corresponding end portion void 610 is shown in FIG. 9. In another embodiment, the impacting arm ends are created separately from the hub/extending arms and attached after curing of both the impacting arm ends and the hub/impacting arms. Thus, in this embodiment, the impacting arm end voids 610 are either not formed or they are filled with a “dummy” end mold that prevents material that forms the hub/impacting arms from forming the impacting end arms.

At block 512, in one embodiment, a compression technique is used to form disk 22 by filling the first mold half 602 with a selected material, such as silicone rubber, polyurethane, rubber, or some other resin, gel, or semi-cured material, filling voids 606, 608, and 610 if it is desired that the disc comprise the same material for hub 400, impacting arms 406, and end portions 408. In one embodiment, the selected material is preheated prior to placement within the voids. In another embodiment, the selected material is introduced only to voids 606 and 608, leaving voids 610 open for a second material having different physical or chemical properties than the selected material.

At block 514, the second mold half 604 is placed on top of the first mold half 602 to form disc mold 600. The two mold halves are typically joined together temporarily by clamping or mechanical fastening means, such as screws, bolts, nuts, etc. In a compression molding technique, the second mold half 604 may be applied with some degree of force, forming a pressure against the selected material(s) in the mold. Heat may additionally be applied to the mold to cure the selected material(s).

At block 516, the disc mold 600 is filled with one or more materials via aperture 620 and/or end portion apertures 618. For example, a first material could be injected into voids 606 and 608 via aperture 620, while a second material having different physical or chemical properties could be injected into voids 610 via end portion apertures 618. In this embodiment, the resulting end portions 408 adhere to the impacting arms 406 via bonding that may occur between the materials as a result of heat and/or pressure, and/or the chemical or physical properties of each of the materials. For example, silicon rubber could be used to form hub 400 and the impacting arms 406, while silicon rubber with a stabilizing additive such an Elastosil® stabilizer marketed by Wacker Chemie AG of Munich, Germany could be used to form end portions 408. The silicon rubber plus additive material used in end portions 408 forms a chemical bond with silicon rubber used in the impacting arms 406 due to their common chemical properties. In another embodiment where it is desired to manufacture disc 22 from the same material, the material can be injected into voids 606, 608, and 610 via aperture 620 only, or it could be injected using both aperture 620 and end portion apertures 618. The disc mold 600 may additionally be heated at this step in order to cure the material(s) inside disc mold 600. In yet another embodiment, the same material can be injected into voids 606 and 608, and then the mold subjected to a predetermined temperature for a predetermined time period to partially achieve one or more desired characteristics (such as high durometer), then additional material injected into voids 610 and additional heat applied, in order to fully cure the material in voids 606 and 608 to fully achieve the desired characteristic(s), while subjecting the material in voids 610 for a shorter duration (and possibly different temperature) to achieve one or more desired characteristics of the impacting arm ends (such as lower durometer, greater coefficient of friction, etc.). This, in effect, allows use of the same material throughout the disc, while achieving different characteristics of the impacting end arms in relation to the impacting arms/hub.

At block 518, after the material(s) inside disc mold 600 have cured, the second mold half 604 is removed from the first mold half 602, allowing disc 22 to be removed from the first mold half 602. The impacting arm end molds 612 may be removed along with disc 22 and then removed from the end portions 408, or they may remain with either the first mold half 602 and/or second mold half 604 when disc 22 is removed from the first mold half 602. The resulting disc 22, thus, comprises a disc comprising impacting arm portions 408 having one or more different physical characteristics than the extending arms/hub, where the impacting arm end portions are either smooth or textured.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

1. A disc for use in a disc screen apparatus, the disc comprising:
a hub having a central bore; and
a plurality of impacting arm elements extending radially therefrom, each impacting arm element comprising an impacting arm and an impacting arm end portion, the impacting arm elements configured for engaging materials to be classified and propelling the materials in a conveying direction when the hub is rotated, at least some of the impacting arm elements comprising texturing imposed on a surface of one of the end portions for engaging the materials as the hub is rotated.

2. The disc of claim 1, wherein the texturing comprises a channel constructed to allow air flow as the hub is rotated.

3. The disc of claim 1, wherein the hub is constructed of a first material and the end portion of at least some of the impacting arm elements are constructed of a second material.

4. The disc of claim 3, wherein the first material comprises a first elastomeric material and the second material comprises a second elastomeric material having different physical properties than the first material.

5. The disc of claim 1, wherein the impacting arms are integrally formed with the hub.

6. The disc of claim 1, wherein the impacting arms are integrally formed with the hub and with the textured, end portions of at least some of the impacting arm elements.

7. A disc screen apparatus for separating materials, comprising:
a frame;
one or more shafts mounted on the frame in a substantially parallel relationship with each other; and
one or more discs mounted on each of the one or more shafts, each disc comprising:
a hub having a central bore; and
a plurality of impacting arm elements extending radially therefrom, each comprising an impacting arm and corresponding end portion, the impacting arm elements configured for engaging materials to be classified and propelling the materials in a conveying direction when the hub is rotated, at least some of the impacting arms comprising texturing imposed on a surface of one of the end portions for engaging the materials as the hub is rotated.

8. The apparatus of claim 7, wherein the texturing comprises a channel constructed to allow air flow as the hub is rotated.

9. The apparatus of claim 7, wherein the hub is constructed of a first material and the end portion of at least some of the impacting arm elements are constructed of a second material.

10. The apparatus of claim 9, wherein the first material comprises a first elastomeric material and the second material comprises a second elastomeric material having different physical properties than the first material.

11. The apparatus of claim 7, wherein the impacting arms are integrally formed with the hub.

12. The apparatus of claim 7, wherein the impacting arms are integrally formed with the hub and with the textured, end portions of at least some of the impacting arm elements.

13. A method of manufacture for a disc used to separate materials, comprising:
forming a first mold half comprising a void in the shape of a hub, voids representing impacting arms extending radially from the hub, and voids representing impacting arm end portions;
forming a second mold half comprising voids corresponding to the first mold half;
forming one or more impacting arm end molds;
placing a respective one of the one or more impacting arm end molds within the first mold half in proximity to a respective impacting arm end portion void;
placing the second mold half on top of the first mold half to form a disc mold;
filling the disc mold with a first material in the disc mold to form the disc;
removing the disc from the disc mold; and
removing the impacting arm end molds from the disc.

14. The method of claim 13, further comprising:
forming an aperture through the first mold half that intersects a first of the voids representing one of the impacting arm end portions; and
filling the first of the voids representing one of the impacting arm end portions with a second material through the aperture.

15. The method of claim 13, wherein forming the one or more impacting arm end molds comprises forming at least one of the impacting arm end molds with grooves on a curved surface.

16. The method of claim 13, wherein at least some of the voids representing impacting arm end portions further comprises a void for receiving one of the impacting arm end molds.

17. The method of claim 13, further comprising:
forming a first aperture half on the first mold half; and
forming a second aperture half on the second mold half corresponding to the first aperture half;
wherein the first material is provided to the disc mold through a first aperture formed when the second mold half is placed over the first mold half.
